(19) United States
(12) Patent Application Publication
(10) Pub. No.: US 2023/0150699 A1
(43) Pub. Date: May 18, 2023

(54) ADJUSTABLE CIRCULAR TUBE ENERGY ABSORPTION/STORAGE MECHANISM BASED ON PAPER-CUT STRUCTURE

(71) Applicant: Taiyuan University of Technology, Taiyuan (CN)

(72) Inventors: Han Wang, Taiyuan (CN); Libiao Xin, Taiyuan (CN); Zhiqiang Li, Taiyuan (CN); Baolong Wang, Taiyuan (CN)

(21) Appl. No.: 17/870,961

(22) Filed: Jul. 22, 2022

(30) Foreign Application Priority Data
Nov. 12, 2021 (CN) 202111336037.8

(51) Int. Cl. B64G 1/62; F16F 7/12

(52) U.S. Cl. CPC B64G 1/62; F16F 7/123

(57) ABSTRACT

An adjustable circular tube energy absorption/storage mechanism based on a paper-cut structure is disclosed according to the present application, which belongs to the technical field of advanced intelligent structure. The mechanism is based on the conventional circular tube and obtained by partially cutting the circular tube. The direction of the slits is along the axial direction of the circular tube. Multiple circular tubes may be arrayed in a specific way according to the actual application requirements. When the circular tube is subjected to axial impact force, the cutting section of the circular tube may deform in a specific direction, the circular tube realizes structural energy absorption and energy storage through local buckling deformation, and after the external force is removed, the circular tube recovers from the deformation and releases stored energy.

### CROSS-REFERENCE TO RELATED PATENT APPLICATION

This non-provisional application claims priority to and the benefit of, pursuant to 35 U.S.C. § 119(a), patent application Serial No. CN202111336037.8 filed in China on Nov. 12, 2021. The disclosure of the above application is incorporated herein in its entirety by reference.

### FIELD

The present application relates to the technical field of advanced intelligent structure, and in particular to an adjustable circular tube energy absorption/storage mechanism based on a paper-cut structure. The idea of the present application is to introduce a paper-cut structure in a local area of a circular tube. By setting characteristic parameters such as the number of support arms, the height and the number of paper-cutting sections, the mechanical response of the mechanism is regulated, so that the mechanism has the characteristics of high specific energy absorption rate and low peak load. In addition, the mechanism may be restored to the original shape after the axial impact load is removed, so that the mechanism can be reused. This adjustable circular tube energy absorption/storage mechanism based on paper-cut structure is expected to be widely used in spacecraft landing systems, various energy absorption structures or anti-impact tools.

### BACKGROUND

The energy absorption performances of materials and structures play a key role in the safety of structures subjected to impact. In practical projects such as aerospace, automobiles, rail vehicles, and offshore platforms, there are strict requirements for the energy absorption performance of structures, especially in the aerospace field, due to the need for safety protection.

From the ShenZhou spacecraft return capsule to the TianGong lunar lander, although a large number of energy absorption structures are used therein to resist the huge impact during landing, hard landing is still inevitable, which threatens the life safety of astronauts and the reliability of electronic components on board. Therefore, a reusable energy absorption and storage system for landing is urgently needed.

However, existing energy-absorbing boxes, tubes, honeycomb structures, etc. all realize energy conversion through plastic deformation or destruction of structures and materials. That is, structures and materials convert most kinetic energy into inelastic energy through plastic deformation or other dissipation processes, instead of storing it in an elastic manner. On one hand, this results in a waste of energy, and on the other hand, this type of energy absorption structure cannot be reused, resulting in a large cost.

### SUMMARY

An object of the present application is to provide an adjustable circular tube energy absorption/storage mechanism based on a paper-cut structure, so as to solve the technical issues that the existing anti-impact structure cannot be recycled and the energy cannot be recovered.

An adjustable circular tube energy absorption/storage mechanism based on a paper-cut structure includes at least one circular tube, where at least one paper-cut section is arranged on each circular tube. In a case that only one paper-cut section is provided, an uncut section is defined between the paper-cut section and two ends of each circular tube. In a case that multiple paper-cut sections are provided, uncut sections are sections between adjacent paper-cut sections, and sections between the paper-cut sections located at two ends and the two ends of each circular tube. Each paper-cut section is provided with at least two slits on a side wall of each circular tube, and two ends of the at least two slits are respectively terminated in two planes perpendicular to an axial direction of each circular tube. The at least two slits are arranged circumferentially around each circular tube at equal spacing, and the tube wall between adjacent slits forms a support arm. Each circular tube is made of superelastic material and elastic material which can recover from deformation after compression. Each circular tube realizes structural energy absorption and energy storage through local buckling deformation, and after the external force is removed, each circular tube recovers from the deformation and releases the stored energy.

This structure is formed by partially cutting the circular tube, and the circular tube is divided into uncut sections and paper-cut sections by cutting. The paper-cut section is defined by two planes (where the two planes are spaced a certain distance) perpendicular to the axial direction of the circular tube. All the slits on each paper-cut section start and end at the above two planes, so as to ensure that the slits on each paper-cut section are parallel to each other and equal in length. Through the above cutting method, the paper-cut section can be divided into a certain number of mutually independent support arms. When the two ends of the circular tube are subjected to external impact, the above structure can realize the buckling deformation of the circular tube, and convert the impact energy into the deformation energy of the cutting section of the circular tube for storage. When the external impact force increases, the same buckling deformation occurs in each support arm of the paper-cut section, where the middle part of the support arm is farthest from the axial direction, while the uncut section is not deformed. After the external force is removed, the circular tube recovers from the deformation and releases the stored energy.

Further, the structural compression deformation may be controlled by adjusting the number of support arms of the paper-cut section, the height of each paper-cut section and the number of paper-cut sections of the circular tube, so as to control the force-displacement response curve of the circular tube.

Further, the present structure is not limited to the case where only one paper-cut section is provided in the middle of the circular tube, but may have multiple paper-cut sections alternately arranged with the uncut sections.

Further, a central angle corresponding to each paper-cut section in the circumferential direction is less than 90 degrees and greater than or equal to 0 degrees.

Further, the circular tube is taken as a structural unit, and multiple units are arranged in array, so as to obtain a mechanism suitable for different environmental working conditions. The array may be linear, triangular or square. In one array, the positions of paper-cut sections in different circular tubes may be the same, or the paper-cut sections may be arranged in staggered rows.

Further, the circular tube material includes, but is not limited to, superelastic material and elastic material which can recover from deformation after compression. For example, the material of the circular tube may be selected from polypropylene and thermoplastic polyurethane elastomer.

According to the present application, the following actions are taken to achieve a stable and repeatable deformation mode: the paper-cut structure is combined with the conventional energy-absorbing circular tube, so as to achieve energy absorption and energy storage through buckling deformation of the paper-cut section; the deformation stroke is prolonged by arranging a large number of arrays of circular tubes; the parameters of the paper-cut structure are designed to meet the corresponding mechanical response parameters. In addition, for the structural unit based on the circular tube, the material therefor can be selected in a wide range, the weight thereof is light, and the specific energy absorption thereof is high. Since each unit is independent of each other, if some of the units fail in actual use, they can be replaced accordingly to reduce the cost of use.

According to the above description, the present application has the following advantages over the conventional technology: energy can be stored, deformation stroke can be extended or shortened according to actual needs, and the structure is stable and has high reusability, light weight, high specific energy absorption, low cost, easy processing and installation, etc.

### BRIEF DESCRIPTION OF DRAWINGS

FIG. 1 is a schematic diagram of an adjustable circular tube energy absorption/storage mechanism based on a paper-cut structure of the present application.

FIG. 2 is a numerical simulation diagram of the deformation, under different strains, of the adjustable circular tube energy absorption/storage mechanism based on a paper-cut structure according to a first embodiment.

FIG. 3 is a force-displacement response curve of the adjustable circular tube energy absorption/storage mechanism based on a paper-cut structure according to the first embodiment under parameter (m) of different values.

FIG. 4 is a numerical simulation diagram of deformation at different stages of the adjustable circular tube energy absorption/storage mechanism based on a paper-cut structure according to the first embodiment when the parameter (m)=4.

FIG. 5 is a schematic diagram of a square array of the adjustable circular tube energy absorption/storage mechanisms based on a paper-cut structure according to a second embodiment.

### DETAILED DESCRIPTION

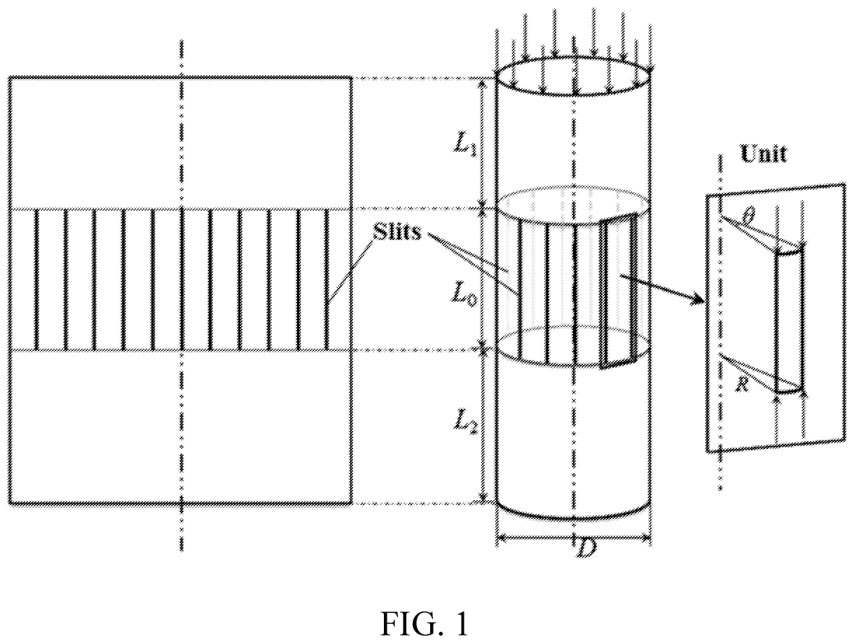

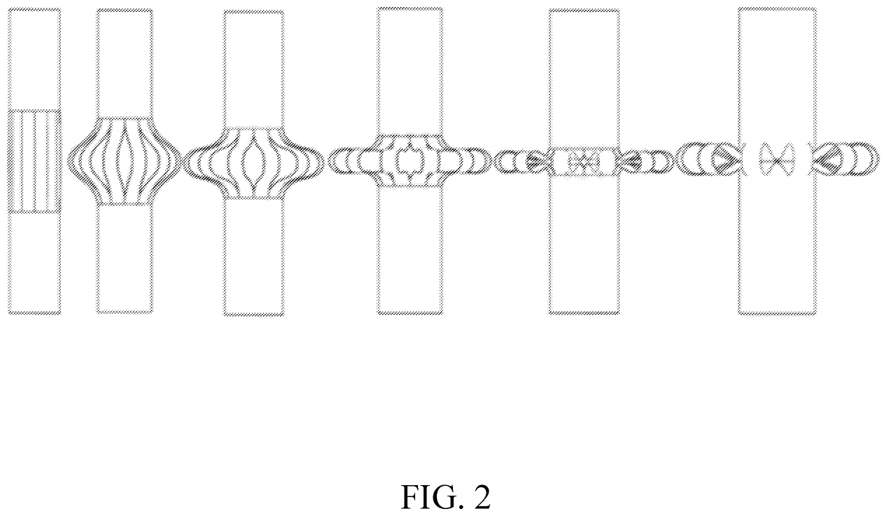

As shown in FIG. 1, in this structure, a circular tube with a uniform diameter D, a wall thickness t and a length L is partially cut, and the circular tube is divided into three sections (two uncut sections and one paper-cut section) by cutting. As shown in FIG. 1, the middle cutting part is a circular tube with a length L0, that is, the paper-cut section; and the uncut sections are circular tubes with lengths L1 and L2. The paper-cut section is cut along the axial direction between two planes perpendicular to the axial direction (the two planes here refer to the two planes at the upper and lower ends of the middle circular tube L0 in FIG. 1), and the cutting height is L0. The paper-cut section is cut into (n) support arms, the central angle corresponding to one support arm is θ, and the cutting is performed at equal spacing. That is, the angle θ shown in the figure is a constant value. The expanded view of the circular tube is shown on the left side of FIG. 1. The direction of the slits on the paper-cut section is parallel to the axial direction of the circular tube. Through the above cutting method, the paper-cut section can be divided into a certain number of mutually independent support arms. Each support arm is part of a cylindrical shell. The buckling deformation of the circular tube can be realized by cutting the circular tube with this method. Assuming that the material of the circular tube is super elastic, the circular tube is still in elastic deformation when it is deformed as shown in FIG. 2. In FIG. 2, the impact energy has been converted into the deformation energy of the cut section of the circular tube for storage. When the compression amount is increased step by step, by 0.2L0 in each step, it can be seen that the same buckling deformation occurs in each support arm of the paper-cut section, where the middle part of the support arm is farthest from the axial direction, while the uncut section is not deformed. After the external load is removed, the paper-cut section recovers from the buckling deformation.

According to the technical solutions of the present application, specific embodiments are selected and described as follows:

### First Embodiment

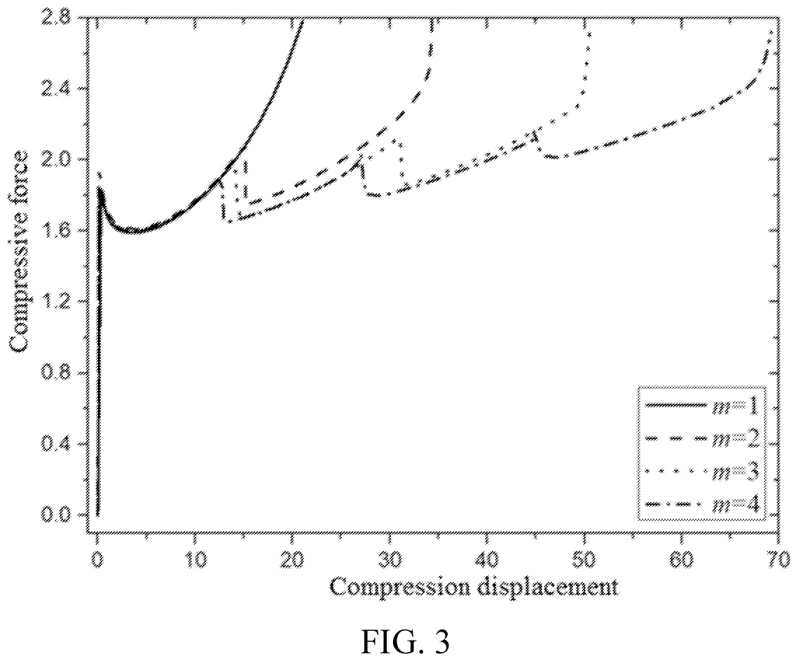

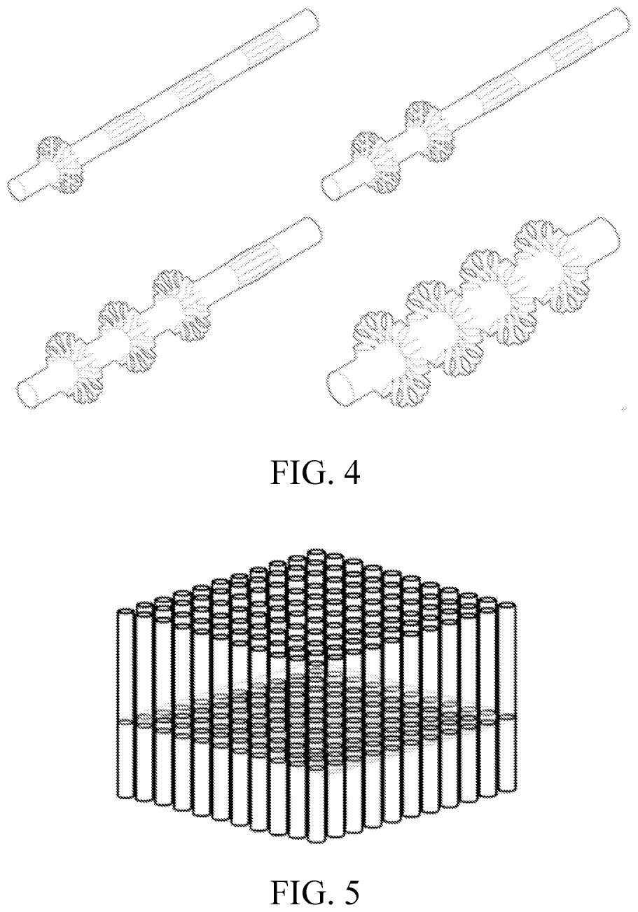

Circular tubes having different numbers (m) of the paper-cut sections are provided, where the numbers respectively are 1, 2, 3 and 4. The height of the paper-cut sections and the uncut sections are both 20 mm, and the number of support arms in each paper-cut section is 12. For the circular tubes having different numbers (m) of paper-cut sections, a static displacement compression load of (20×m) mm is applied respectively, and the force-displacement response curves of different structures are obtained, as shown in FIG. 3. FIG. 4 shows the deformation simulation diagram of the circular tube having four paper-cut sections at different stages. For the circular tube having (m) paper-cut sections, (m) times of destabilization may occur during the entire deformation process, that is, there are (m) critical buckling stresses. As the number (m) increases, the force-displacement response curve of the circular tube becomes longer and gentler, which means that the deformation stroke thereof is longer, which may provide reference for designing structures with good energy absorption characteristics.

### Second Embodiment

As shown in FIG. 5, 11×11 circular tubes in the first embodiment are used to form a square array. The circular tubes are equally spaced, and are placed in a perforated plate as shown in the figure (the number of plates can be appropriately increased) to fix the positions of the circular tubes. The total height of the circular tubes, the spacing between adjacent circular tubes, and the position of the paper-cut section may be freely selected according to the actual situation.

The above described embodiments are only preferred embodiments of the present disclosure and are not intended to limit the present disclosure in any way. Any simple modifications, changes, and equivalent substitutions made to the above embodiments according to the technical essence of the present disclosure still fall within the protection scope of the technical solutions of the present disclosure.

What is claimed is:

1. An adjustable circular tube energy absorption/storage mechanism based on a paper-cut structure, comprising:
at least one circular tube,
wherein a plurality of paper-cut sections are arranged on each circular tube, uncut sections are sections between adjacent paper-cut sections, and sections between the paper-cut sections located at two ends and the two ends of each circular tube; wherein each paper-cut section is provided with at least two slits on a side wall of each circular tube, and two ends of the at least two slits are respectively terminated in two planes perpendicular to an axial direction of the corresponding circular tube; wherein the at least two slits are arranged circumferentially around the corresponding circular tube at equal spacing, and a tube wall between adjacent slits forms a support arm; wherein each circular tube is made of superelastic material and elastic material which is able to recover from deformation after compression; wherein each circular tube realizes structural energy absorption and energy storage through local buckling deformation, and after an external force is removed, each circular tube recovers from the deformation and releases stored energy; wherein structural compression deformation is controlled by adjusting the number of support arms of each paper-cut section, the height of each paper-cut section and the number of paper-cut sections of each circular tube, so as to control a force-displacement response curve of each circular tube.

2. The adjustable circular tube energy absorption/storage mechanism based on a paper-cut structure according to claim 1, wherein the circular tube is made of polypropylene or thermoplastic polyurethane elastomer.

3. The adjustable circular tube energy absorption/storage mechanism based on a paper-cut structure according to claim 1, wherein a central angle corresponding to each paper-cut section in a circumferential direction is less than 90 degrees and greater than or equal to 0 degrees.

4. The adjustable circular tube energy absorption/storage mechanism based on a paper-cut structure according to claim 1, comprising a plurality of circular tubes arranged in an array, wherein the array is linear, triangular or square.

5. The adjustable circular tube energy absorption/storage mechanism based on a paper-cut structure according to claim 2, comprising a plurality of circular tubes arranged in an array, wherein the array is linear, triangular or square.

6. The adjustable circular tube energy absorption/storage mechanism based on a paper-cut structure according to claim 3, comprising a plurality of circular tubes arranged in an array, wherein the array is linear, triangular or square.

7. The adjustable circular tube energy absorption/storage mechanism based on a paper-cut structure according to claim 4, wherein in the array, positions of the paper-cut sections in different circular tubes are the same, or the paper-cut sections are arranged in staggered rows.
